(19) United States
(12) Patent Application Publication
(10) Pub. No.: US 2024/0336428 A1
(43) Pub. Date: Oct. 10, 2024

(54) DEVICE FOR OPENING AND/OR CLOSING OF WASTE CONTAINERS

(71) Applicant: VIBO S.p.A., Trissino (Vicenza) (IT)

(72) Inventor: Francesco BONIN, Trissino (Vicenza) (IT)

(21) Appl. No.: 18/579,143

(22) PCT Filed: Jul. 14, 2022
(86) PCT No.: PCT/IB2022/056498

§ 371 Date: Jan. 12, 2024

(30) Foreign Application Priority Data
Jul. 15, 2021 (IT) 102021000018785
Oct. 29, 2021 (IT) 102021000027902

(51) Int. Cl. B65F 1/14; A47B 77/18; A47B 97/00

(52) U.S. Cl. CPC B65F 1/1436; A47B 77/18; A47B 97/00

(57) ABSTRACT

A device to operate the opening and/or closing of at least one covering element for one or more containers, for example waste containers, positioned on a drawer of a piece of furniture (F) which moves along a direction of extraction or retraction (X), includes a movement element for the covering element and connected to the latter, and actuation components locally fixed with said furniture (F), wherein during the extraction or retraction of the drawer there is the consequent opening or closing of the covering element, in the extraction position it is also possible to manually close the drawer and in the subsequent retraction of the drawer the device keeps the covering element closed without interference.

### TECHNICAL FIELD OF THE INVENTION

The present invention relates to a device for operating the opening and/or closing of containers and, specifically, a device for operating the opening and/or closing of containers for waste or for separate collection.

### STATE OF THE ART

Generally, waste collection containers are placed in the kitchen below the sink, for example in a sliding drawer that can be opened at will. Furthermore, the space under the sink, in addition to being used for the positioning of waste containers, can be used to place other objects, such as products useful for cleaning the kitchen or hob or the like and/or other products.

The state of the art provides that the waste containers are provided with a lid which, once the drawer is opened, is automatically raised.

In this way, the user can, by simply opening the drawer, also lift the lid of the waste containers and easily deposit the garbage in them.

However, in the event that the user wants to access the objects or compartments positioned behind the containers—instead of throwing waste in them—the automatic opening of the lid considerably complicates access to the objects or compartments since the size of the lid in the raised position does not allow the user to access the area behind the containers and therefore does not allow any object to be removed.

The user must then deactivate the automatic opening mechanism and completely extract the drawer from the sliding guide to which it is operatively associated to pick up and/or place an object.

It is therefore necessary to create a device to operate the opening and/or closing of containers that allows to overcome the disadvantages described above.

### SUMMARY OF THE INVENTION

The main object, therefore, of the present invention is to improve the state of the art concerning the devices to operate the opening and/or closing of containers, in particular of containers for the separate collection of waste.

Another object of the present invention is to provide a device to operate the opening and/or closing of containers capable of easily allowing an external user to access any objects positioned in a rear area with respect to the containers.

A further object of the present invention is to provide a device for operating the opening and/or closing of containers that is easy to install.

Yet another object of the present invention is to provide a device to operate the opening and/or closing of containers that is reliable and easy to use.

According to an aspect of the present invention, a device to operate the opening and/or closing of at least one container according to the present application is provided.

The present application refers to preferred and advantageous forms of the invention.

### BRIEF DESCRIPTION OF THE DRAWINGS

Further characteristics and advantages of the present invention will become more evident from the detailed description of a preferred, non-exclusive embodiment of a device for operating the opening and/or closing of containers illustrated by way of example, but not of limitation, in the accompanying drawings of drawings in which:

FIGS. 1 and 2 are respectively a perspective view and a side view of an example of embodiment of a device, according to the present invention, with some parts removed to better illustrate others, in a first position of use;

FIGS. 3 and 4 are respectively a perspective view and a side view of an example of embodiment of a device of FIGS. 1 and 2, with some parts removed to better illustrate others, in a second position of use;

FIGS. 5 and 6 are respectively a perspective view and a side view of an example of embodiment of a device of the previous figures, with some parts removed to better illustrate others, in a second position of use with a different modality compared to the FIGS. 3 and 4;

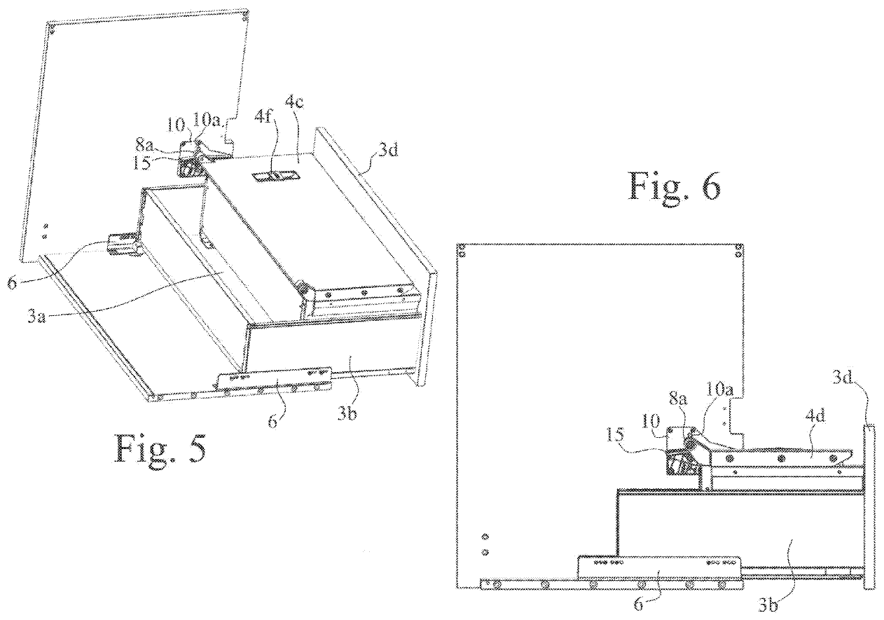

FIGS. 7, 8 and 9 show a sequence of operation of some details of an example of embodiment of a device of the preceding figures in the second position according to the different mode of use;

FIG. 10 shows a detail according to an example of embodiment of the device of the previous figures with a part made transparent for better intelligibility;

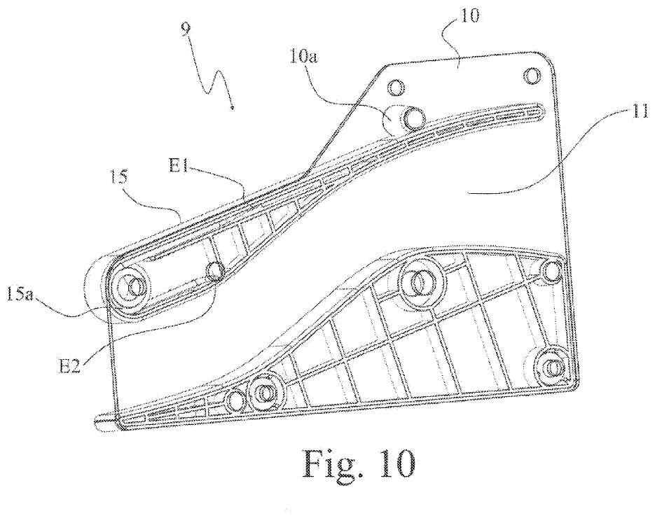

FIGS. 11 and 12 are perspective views of some details of an example of embodiment of a device of the preceding figures;

FIG. 13 shows an enlarged detail of some components of an example of embodiment of a device of the preceding figures;

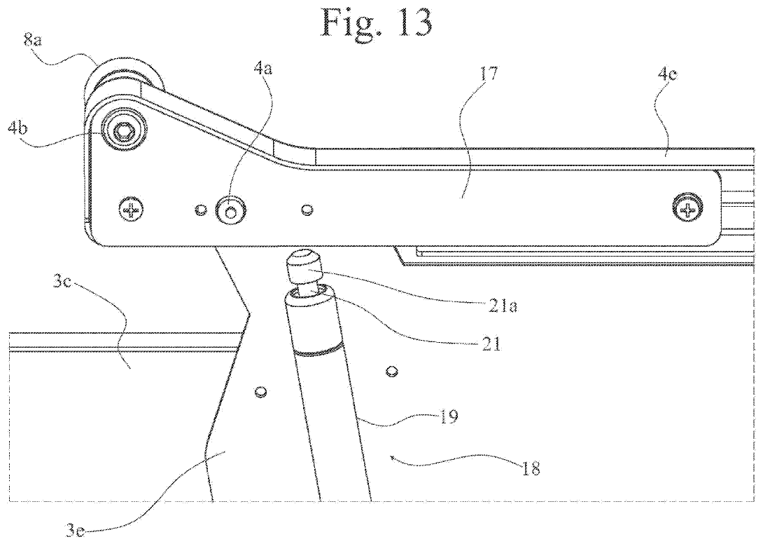

FIGS. 14 and 15 show a sequence of operation of some components of an example of embodiment of a device of the preceding figures;

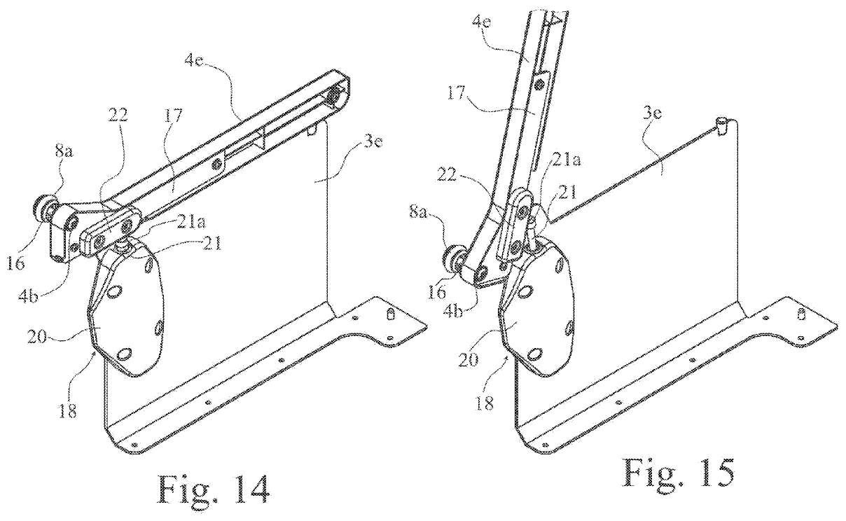

FIGS. 16 and 17 show respectively a perspective view and a side view of another embodiment of a device according to the present invention, and

FIG. 18 shows another non-limiting embodiment of a component of the device according to the present invention.

### DETAILED DESCRIPTION OF THE INVENTION

With reference to the attached figures, a device 1 to operate the opening and/or closing of at least one container 2 is indicated as a whole with the reference number 1.

This device 1 can be mounted and/or fixed in a piece of furniture F under any sink, which piece of furniture F can in turn comprise at least two opposite walls W.

However, as it will be understood, the present invention could also be used in other positions, for example mounted and/or fixed inside any element containing objects such as a drawer, a wardrobe, a shelf, etc.

In particular, in the non-limiting example of embodiment of the present invention illustrated in the figures, the device 1 is mounted and/or fixed internally to a drawer, if desired positioned under a kitchen sink.

In the continuation of the description, reference will be made to containers particularly suitable for the collection of waste or for separate collection, however, as it will be understood these containers could be suitable for containing any other object without any limitation.

The device 1 for operating the opening and/or closing of at least one container 2 comprises a support or containment element 3, for example a drawer, for positioning or supporting at least one container 2 and, according to a non-limiting example of embodiment of the present invention, also for one or more receptacles (not shown in the figures), which in turn contain any object, for example positioned, in use, in a posterior zone ZP to the at least one container 2, as well as opening and/or closing means 5 of at least one covering element 4 hinged in at least one pin 4a.

Of course, according to another version of the invention, the receptacles may also not be present or there may be only one or more objects (also not shown in the figures) without the receptacles.

The container 2 can be of any configuration, and able to contain any object.

Moreover, according to the dimensions of the piece of furniture F in which the device 1 is mounted and/or fixed, more containers 2 can also be provided, for example two, three or more containers 2 positioned on or laid on the support or containment element 3.

According to the non-limiting example of embodiment of the invention illustrated in the figures, there are three containers 2 having a substantially square configuration and particularly suitable for the containment or collection of waste and/or for separate collection.

As for the support or containment element 3, it is operatively associated in a sliding way and therefore movable on guide means 6, for example linear guides for drawers.

More in detail, the support or containment element 3, which according to the non limiting example of embodiment of the invention illustrated in the figures is a sliding drawer, can comprise a main face 3a which acts as a support for supporting or containing both of the at least one container 2, both of the one or more receptacle and at least two side walls 3b, 3c associated in a sliding manner with the guide means 6, a front door or wall 3d, in use, which can be opened and/or closed by a user through the application of a linear movement of extraction or retraction of the support or containment element 3 and, if desired, also a rear wall 3g, in use.

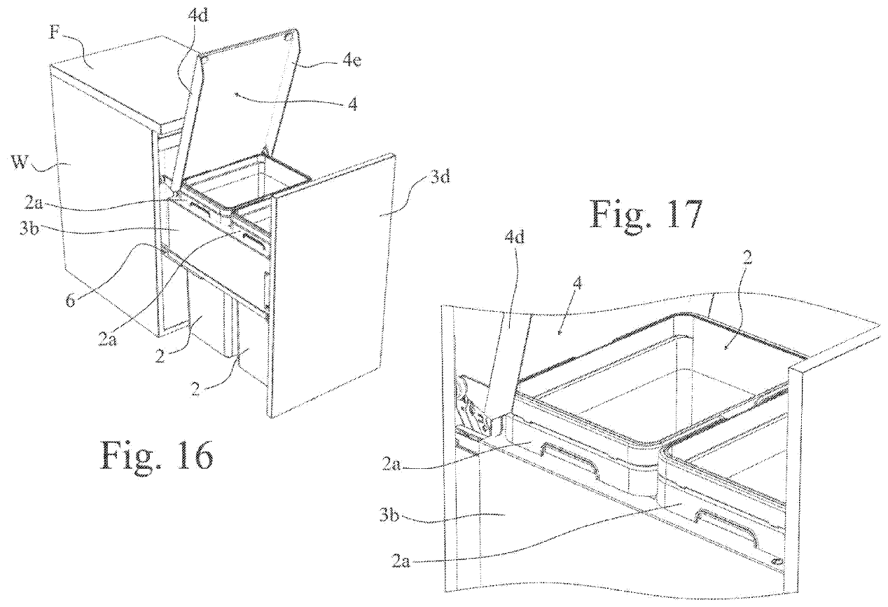

According to the non-limiting example of embodiment of the present invention shown in FIGS. 16 and 17, the support or containment element 3 comprises only two side walls 3b, 3c and a front door or wall 3d, in use.

In this regard, the at least one container 2 can advantageously comprise at least a coupling portion or component 2a, for example an enlarged portion, configured to be operatively coupled, for example in a removable way, with the side walls 3b, 3c of the support or containment element 3.

Basically, the at least one coupling portion or component 2a can be coupled to the side walls 3b, 3c so that the latter can support the at least one container 2 even if the latter does not include the main face 3a.

As can be understood, in this case the support of the at least one container 2 is provided by the coupling of the coupling portion or component 2a with the side walls 3b, 3c.

In the non-limiting example of embodiment of the present invention illustrated in the figures, the guide means 6 comprise two parallel linear sliding guides for the support or containment element 3 fixed on the two opposite walls W of the piece of furniture F.

The guide means 6 define an extraction or retraction direction X for the support or containment element 3 substantially horizontal or parallel to the ground.

The user of the device 1 can apply, through a linear movement, a first force to the front door or wall 3d, in use, along the extraction direction X to extract the support or containment element 3.

In the same way, the user of the device 1 can apply, again through a linear movement, a second force in the opposite direction to the first force, to the front door or wall 3d, in use, along the retraction direction X to retract the support or containment element 3.

As regards the opening and/or closing means 5 for the covering element 4, they comprise at least movement means 8 of the covering element 4 and at least actuation means 9, locally fixed with the furniture F, to actuate the movement means 8.

These actuation means 9, in the non-limiting example of embodiment of the invention illustrated in the figures, comprise a support 10 fixed and/or mounted, by means of suitable fastening means such as screws or rivets, on the internal wall W of the piece of furniture F.

The support 10 preferably comprises at least one groove 11 within which the movement means 8 slide.

Basically, the movement means 8 preferably comprise an element capable of sliding inside or on at least one groove 11 made in the support 10, for example a shoe in anti friction material or a roller, as shown in the figures.

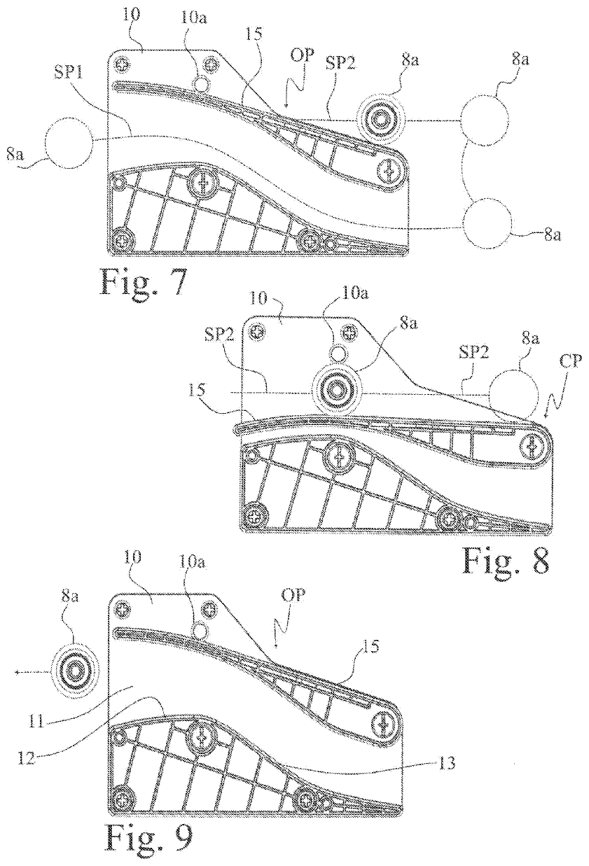

According to what is illustrated in more detail in FIGS. 7, 8 and 9, the groove 11 comprises a first groove section 12 substantially parallel to the extraction or retraction direction X and a second groove section 13 inclined towards the ground.

Furthermore, the actuation means 9 or, more particularly, the groove 11 can advantageously comprise, in use, an upper portion 14 defined by or which comprises at least one rotatable or displaceable component 15 movable between an open operating position OP, in which this rotatable or displaceable component 15 defines with the sections 12, 13 a first sliding path SP1 for the movement means 8 and a closed operating position CP, in which this rotatable or displaceable component 15 defines a second sliding path SP2 for the movement means 8.

More particularly, this rotatable or displaceable component 15 is able, following the abutment or thrust of the movement means 8 thereon, to move from the open operating position OP to the closed operating position CP so as to define the second sliding path SP2.

The rotatable or displaceable component 15 is therefore an element connected in a rotational manner to the support 10, for example by means of a pin, and can be operated by the abutment or by the thrust of the movement means 8 thereon so that it rotates by the angle necessary to allow the movement means 8 to travel along the second sliding path SP2, which is, in fact, delimited, in use, by the upper section of the rotatable or displaceable component 15.

From a structural point of view, the rotatable or displaceable component 15, according to the non-limiting example of embodiment of the present invention shown in the figures, has a substantially wing configuration.

Furthermore, the rotatable or displaceable component 15 preferably comprises elastic means 15a, for example a spring, operatively associated with it and configured to allow the rotatable or displaceable component 15 to pass from the closed operating position CIP to the open operating position OP once the movement means 8 no longer encounter with or are no longer resting on the rotatable or displaceable component 15.

In particular, the elastic means 15a are preferably inserted or engaged in a specific housing seat HA delimited in the rotatable or displaceable component 15.

More in detail, the elastic means 15a can comprise a first end E1 integral with the rotatable or displaceable component 15 and a second end E2 connected with the support 10 so as to allow the accumulation of elastic energy during the passage of the rotatable or displaceable component 15 from the open operating position OP to the closed operating position CP and the subsequent release of this energy in the form of mechanical energy for causing the passage of the rotatable or displaceable component 15 from the closed operating position CP to the open operating position OP.

Furthermore, the support 10 can comprise a stop element 10a configured to abut with the rotatable or displaceable component 15 so as to delimit the open operating position OP of the same.

Basically, in the open operating position OP the rotatable or displaceable component 15 is in contact with the stop element 10a so as to delimit the first sliding path SP1, in the closed operating position CP the rotatable or displaceable component 15 is not contact with the stop element 10a so as to delimit the second sliding path SP2 while in the transition from the closed operating position CP to the open operating position OP the stop element 10a acts as a limit switch for the rotatable or displaceable component 15 which can thus return to the open operating position OP and delimit again the first sliding path SP1 for a possible new cycle of use of the device 1.

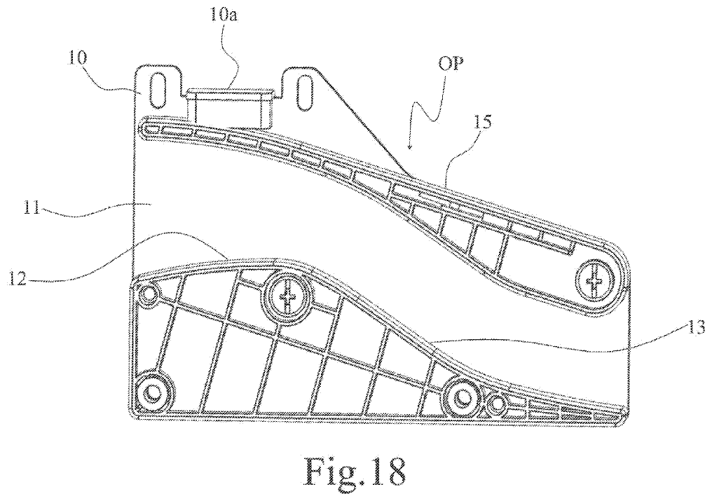

According to the non-limiting example of embodiment of the stop element 10a shown in FIG. 18, it can be or comprise a cushion element configured to cushion the impact of the rotatable or displaceable component 15 and thus make the device 1, in use, quieter.

From a mechanical point of view, the first groove section 12 and the second groove section 13 constitute a linear cam and the movement means 8 constitute a cam follower. In particular, through the movement of the cam follower in or on the linear cam it is possible to open and/or close the covering element 4.

In general, therefore, the actuation means 9 delimit a first sliding path SP1 in which the movement means 8 move to cause the opening of the covering element 4 following a first extraction displacement SI of the support element or containment 3 and the closure of the covering element 4 following a second retraction displacement S2 of the support or containment element 3, and a second sliding path SP2 in which the movement means 8 move to determine the maintenance of the closure of the covering element 4 following a manual closure of the covering element 4 and of the second retraction displacement S2 of the support or containment element 3.

It should be noted that the manual closure of the covering element 4 can take place, for example, by a user or by any other external agent.

In other words, when the movement means 8 travels along the first sliding path SP1 in the extraction or retraction direction X, the first section 12, the second section 13 and the rotatable or displaceable component 15 in the open operating position OP, delimit this first sliding path SP1 for the movement means 8.

On the other hand, when the movement means 8, following the manual closure of the covering element 4, begin to move in the retraction direction X, they encounter with or rest on the rotatable or displaceable component 15, which passes from the open operating position OP to the closed operating position CP so as to delimit the second sliding path SP2 for the movement means 8.

In the non-limiting example of embodiment of the present invention illustrated in the figures, the movement means 8 comprise at least one roller 8a, optionally equipped with a rubber ring to achieve silent operation when it slides in the groove 11.

Each roller is connected by means of a fastening 4b to the covering element 4 in the opposite position with respect to the at least one pin 4a.

In the version of the invention illustrated in the figures, the roller is connected to a spacer sleeve 16 which has a first end 16a connected to this roller 8a and a second end 16b connected to the fastening 4b.

Thanks to the spacer sleeve 16, the roller 8a is located at the right distance from the support or containment element 3 and so as to allow it to slide easily in the groove 11.

As mentioned, the movement means 8 could also be a shoe made of anti-friction material, a pin, a bearing or in any case any element capable of being operated by the actuation means 9 for opening and/or closing the covering element. 4.

As regards the covering element 4, it comprises at least one main wall 4c as well as two side walls 4d, 4e connected or hinged in a rotating manner, by means of the pin 4a, to a respective support 3e, 3f fixed and/or mounted stably on the support or containment element 3 or better on the main face 3a of the support or containment element 3, by means of suitable connection means 17 such as for example screws or rivets.

In addition, the covering element 4 can comprise, for example mounted and/or fixed on the main wall 4c, an odor limitation filter 4f, and more particularly an activated carbon filter.

This filter 4f can be conveniently used for the attenuation and/or elimination of any odors coming out of at least one container 2.

Furthermore, the side walls 4d, 4e can comprise at least one reinforcing element 17 connected and/or joined to the area where the fastening 4b for the roller 8a is located.

This element 17 can be made of metal so as to provide the side walls 4d, 4e with greater solidity.

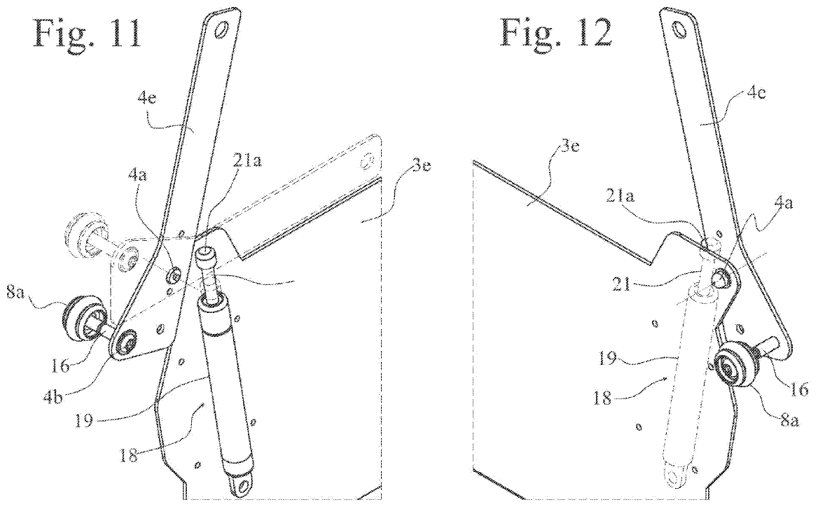

The device 1 can also comprise a cushion or support assembly 18 for the covering element 4, according to what is illustrated in the non-limiting embodiment of the invention shown in the attached figures (see in particular FIGS. 11 and 12).

The cushion or support assembly 18 preferably comprises a so-called gas spring 19, which can be enclosed in a casing 20.

As is known, a gas spring is a hydropneumatic adjustment element consisting of a cylinder, a rod with a piston and suitable end connections.

Generally, the compressed gas with which the cylinder is filled is nitrogen; inside the cylinder, the gas, at the same pressure, acts both on the upper face and on the lower face of the piston, which, having different sections, create a force in the direction of extension. This extension force can be precisely defined by selecting the right filling gas pressure. In addition, hydraulic damping can be provided, obtained with a certain amount of oil inside the cylinder that passes through specially provided holes in the piston, allowing a smooth and damped extension movement.

The gas spring 19 comprises a stem 21, in use, with an upper end 21a in contact with at least a portion or a component of the covering element 4, so as to cushion and/or support the covering element 4 during the closing and/or opening phases.

This cushion or support assembly 18 is, in the version of the invention illustrated in the figures, mounted and/or fixed at each support 3e, 3f.

At each pin 4a, at least one abutment element 22 can also be provided for the cushion or support assembly 18 or better for the upper, in use, end 21a of the stem 21.

This abutment element 22 can be mounted and/or fixed on the respective side wall 4d, 4e of the covering element 4, so that its movement is integral with the movement of the side wall 4d, 4e itself.

During the closing phase of the covering element 4, the upper end 21a of the stem 21 varies the point of contact on the abutment element 22, decreasing the lever arm on which it acts, cushioning and allowing the closing of the covering element 4.

Similarly, during the opening phase of the covering element 4, the contact point of the upper end 21a on the abutment element 22 varies, increasing the lever arm on which it acts, and the stem 21 exiting the cylindrical body of the gas spring 19, supports the open position of the covering element 4.

The cushion or support assembly 18 can also be made with a different elastic element, for example by means of a mechanical spring.

The movement or the trajectory of the movement means 8 along the sliding paths SP1, SP2 can be geometrically defined through its decomposition into a horizontal component of movement along the direction of extraction or retraction X and in a vertical component of movement along a vertical direction perpendicular to the extraction or retraction direction X.

The horizontal component of movement of the movement means 8 has no effect on the covering element 4 while the vertical component of movement of the movement means 8 is what actually determines the opening or closing or, more generally, the raising or lowering, of the covering element 4.

In particular, a vertical movement of the movement means 8 along the vertical downward direction determines the opening or in any case the raising of the covering element 4, while a vertical movement of the movement means 8 along the vertical upward direction determines closing or in any case lowering of the covering element 4.

An example of operation of device 1 is then described.

The support or containment element 3, associated with the guide means 6, is in a retracted position along the extraction or retraction direction X with the covering element 4 closed.

The user can apply a first force to the front door or wall 3d, in use, along the extraction direction X to extract the support or containment element 3 through a first displacement SI: the movement means 8 then begin to slide until it enters the first sliding path SP1 delimited by the actuation means 9, and in particular by the rotatable or displaceable component 15 and by the first and second sections 12, 13 of the groove 11

The first section 12, being parallel to the extraction direction X, does not cause any vertical movement of the movement means 8, which therefore do not act on the covering element 4.

As soon as the movement means 8 begin to slide in the second section 13 inclined towards the ground, they necessarily also move along a vertical movement component.

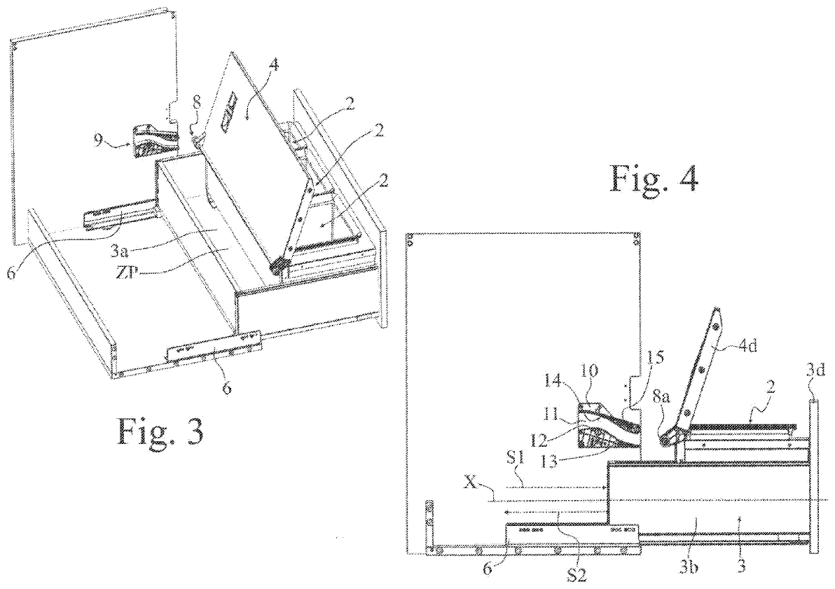

The movement means 8 being connected to the fastening 4b of the respective side wall 4d, 4e of the covering element 4, progressively open the latter until the movement means 8 finish traveling along the second section 13 of the groove 11. In the meantime, during the opening of the covering element 4, the cushion or support assembly 18 supports and keeps open the covering element 4 once the end of the second section 13 of the groove 11 has been reached (see for example FIGS. 3 and 4).

The user therefore has two options available: the first is to retract the support or containment element 3 along the retraction direction X by means of a second displacement S2.

In this case, the movement means 8 will begin to slide through the first sliding path SP1 in the opposite direction with respect to the forward direction and, in particular, through the second section 13 of the groove 11, moving along a vertical movement component, and consequently, closing the covering element 4.

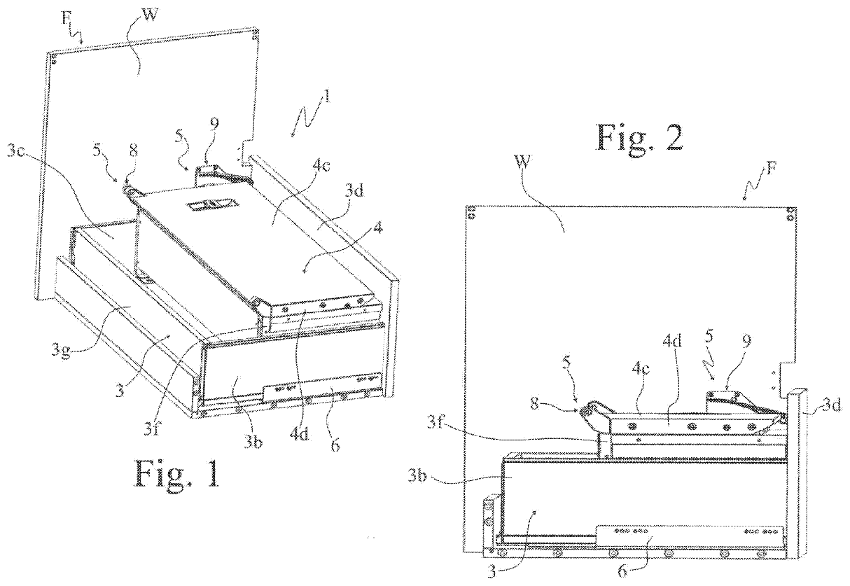

Subsequently, the movement means 8 after having traversed the second section 13 of the groove arrive at the first section 12 of the groove, which, being parallel or substantially parallel to the extraction or retraction direction X, does not have a vertical movement component and does not modify hence the position of the covering element 4. The support or containment element 3 is therefore in the retracted position and the covering element 4 is closed (see for example FIGS. 1 and 2).

The operating cycle can then restart.

The second option is that the user closes the covering element 4 manually, for example to be able to more easily access the posterior zone ZP where the containers 2 are located. This closure causes the movement of the movement means 8, i.e., the roller 8a, from a lowered position to a raised position.

This displacement, generated by the manual closure of the covering element 4, places the movement means 8 in a position such that the subsequent retraction of the support or containment element 3 following a displacement S2 along the retraction direction X allows to the same to abut or push on the rotatable or displaceable component 15 (see FIG. 7), which moves from the open operating position OP to the closed operating position CP, thus defining the second sliding path SP2 for the movement means 8.

The handling means 8 then move in retraction, in use, along the upper surface of the rotatable or displaceable component 15 that accompanies this retraction movement (see FIG. 8).

The second sliding path SP2 does not possess or in any case possesses substantially zero vertical displacement components since the movement means 8 move in retraction along a direction parallel to the ground and, therefore, the closure of the covering element 4 is maintained.

Subsequently, as soon as the movement means 8 no longer encounter or push or are no longer resting on the rotatable or displaceable component 15, the latter moves from the closed operating position CP to the open operating position OP thanks to the elastic means 15a which they release the elastic energy accumulated during the passage of the same from the opening position OP to the closing position CP.

The support or containment element 3 is therefore in the retracted position and the covering element 4 is closed.

It should be noted that the transition from abutment or thrust to non-abutment or thrust or, in any case, to non-contact of the rotatable or displaceable component 15 with the movement means 8 occurs since the latter continue along the retraction direction X until the support element or containment 3 is fully retracted (see FIG. 9).

The operating cycle is completed and can then be restarted with a new extraction of the support or containment element 3.

During the present description, the operating mechanism of the device 1 has been described with reference to a single wall W of the piece of furniture F, however, as can be understood, this device can be present symmetrically on both opposite walls W of the piece of furniture F or in any case of the container of objects in question such as, for example, a drawer, a wardrobe, a shelf, etc. Operation therefore remains the same for both opposite walls W of the piece of furniture F.

The device 1 for operating the opening and/or closing of at least one container according to the present invention is able to easily allow an external user to access any objects positioned in a zone behind the containers.

The device 1 also has a simple and intuitive operation since it allows the manual closure of the covering element 4 without the risk of damaging the device 1 itself.

Furthermore, the device 1 is easy to install, as it can in fact be mounted and/or fixed internally to a piece of furniture having any configuration.

Moreover, the device 1 according to the present invention has a high degree of reliability and ease of use as it uses the least possible number of components to manage the opening and/or closing operations.

It has thus been seen that the present invention fully achieves the proposed aims.

The device 1 thus conceived is susceptible of numerous modifications and variations, all falling within the scope of the inventive concept.

Furthermore, all the details can be replaced by other technically equivalent elements.

In practice, the materials used, as well as the contingent shapes and dimensions, may be any according to requirements without thereby departing from the scope of the protection of the following claims.

1. A device for operating the opening and/or closing of at least one container positioned on or supported by a support or containment element inside a piece of furniture (F), said support or containment element being operatively associated with guide means and being able to move along at least one extraction or retraction direction (X), comprising at least one container equipped with a covering element hinged in at least one pin and opening and/or closing means of said at least one covering element wherein said opening and/or closing means comprise at least movement means of said covering element and of the actuation means, locally fixed with said furniture (F), to actuate said movement means, said actuation means defining:
a first sliding path (SP1) in which said movement means move to cause the opening of said at least one covering element following a first extraction displacement (SI) of said support or containment element and the closure of said at least one covering element following a second retraction displacement (S2) of said support or containment element, and
a second sliding path (SP2) in which said movement means move to determine the maintenance of the closure of said at least one covering element following a manual closure of said at least one covering element and of said second retraction displacement (S2) of said support or containment element.

2. The device according to claim 1, wherein said movement means comprise a roller or a shoe connected to said covering element by means of a fastening in the opposite position to said at least one covering element, with respect to said at least one pin.

3. The device according to claim 1, wherein said at least actuation means comprise a support provided with at least one groove said movement means sliding into said at least one groove.

4. The device according to claim 3, wherein said at least one groove comprises at least a first groove section substantially parallel to the extraction or retraction direction (X) and at least a second groove section inclined downwards so as to define said first sliding path (SP1) for said movement means.

5. The device according to claim 4, wherein said groove comprises an upper, in use, portion defined by or comprising at least one rotatable or displaceable component movable between an open operating position (OP), in which said rotatable or displaceable component defines with said sections of said groove said first sliding path (SP1) for said movement means and a closed operating position (CP), in which said rotatable or displaceable component defines said second sliding path (SP2) for said movement means.

6. The device according to claim 5, wherein said at least one rotatable or displaceable component, following the abutment or thrust of said movement means thereon, moves from said open operating position (OP) to said closed operating position (CP) so as to define said second sliding path (SP2) for said movement means.

7. The device according to claim 5, wherein said at least one rotatable or displaceable component comprises elastic means operatively associated therewith and configured to allow the passage of said rotatable or displaceable component from said closed operating position (CP) to said open operating position (OP) once said movement means no longer abut or push or are no longer laid on said rotatable or displaceable component.

8. The device according to the claim 7, wherein said elastic means are inserted or fitted in a suitable housing seat (HA) delimited in said rotatable or displaceable component, said elastic means comprising a first end (E1) integral with said rotatable or displaceable component and a second end (E2) connected with said support so as to allow the accumulation of elastic energy during the passage of said rotatable or displaceable component from said open operating position (OP) to said closed operating position (CP) and the subsequent release of this energy under the form of mechanical energy for causing the passage of said rotatable or displaceable component from said closed operating position (CP) to said open operating position (OP).

9. The device according to claim 5, wherein said support comprises a stop element configured to abut with said rotatable or displaceable component so as to delimit said open operating position (OP) of the same.

10. The device according to claim 1, wherein said covering element comprises at least one main wall as well as two side walls rotatably connected to a respective support fixed and/or mounted stably on said support or containment element.

11. The device according to the preceding claim 10, wherein each of said two side walls comprises at least a reinforcing element connected and/or joined to said fastening.

12. The device according to claim 1, wherein said guide means are two parallel sliding guides for said support or containment element fixed and/or mounted on two opposite walls (W) of said furniture (F).

13. The device according to claim 1, comprising a cushion or support assembly for said covering element.

14. The device according to claim 13, wherein said cushion or support assembly comprises at least a gas spring, or an elastic element, with a stem provided with at least one upper, in use, end in contact with at least one abutment element of said covering element.

15. The device according to claim 14, wherein, during the opening or closing of said covering element, said upper end of the stem varies the point of contact on said abutment element, increasing or decreasing the lever arm on which it acts, cushioning and allowing the opening or closing of said covering element.

16. The device according to claim 1, wherein said covering element comprises at least one odor limitation filter.
